(19) United States
(12) Patent Application Publication
(10) Pub. No.: US 2003/0052532 A1
(43) Pub. Date: Mar. 20, 2003

(54) Automated activation strategy for a vehicle brake system

(76) Inventors: Robert E. Costello, Shelby Township, MI (US); Dennis A. Kramer, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 09/952,916

(22) Filed: Sep. 14, 2001

(51) Int. Cl. B60T 13/00

(52) U.S. Cl. 303/7; 303/20

(57) ABSTRACT

A vehicle brake system includes an automated brake application feature. A signaling device allows an individual to generate a signal indicating a desire to have the brakes applied independent of the pedal normally used to apply the brakes. A remote signaling device using wireless communication allows an individual to stand at any location within the vicinity of the vehicle and have the brakes applied without requiring someone to manually operate the pedal device to operate the brakes. The inventive arrangement allows an individual to inspect the operation of brake components and to insure that brake lights are properly functioning.

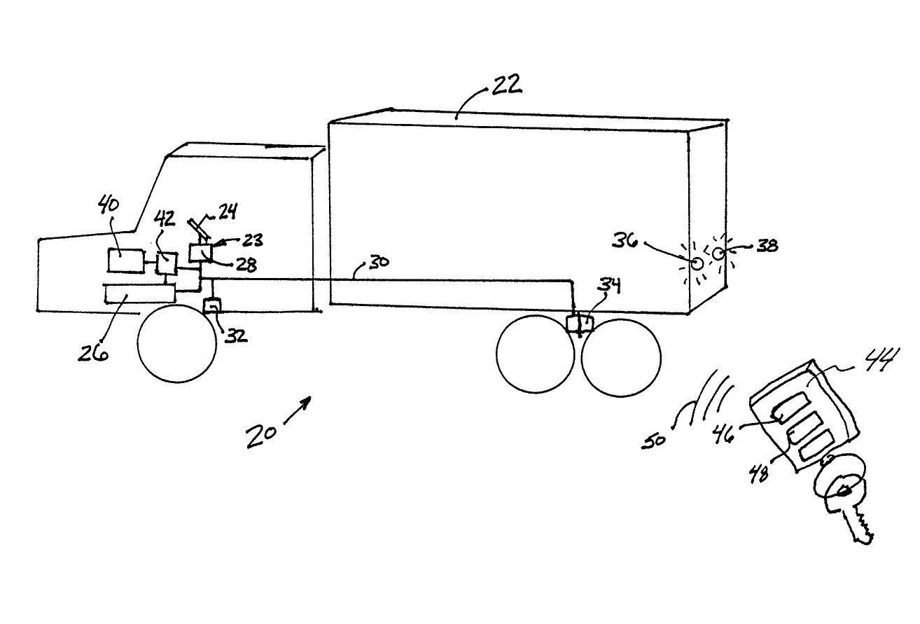

### BACKGROUND OF THE INVENTION

This invention generally relates to vehicle brake systems. More particularly, this invention relates to a vehicle brake system including a remote activation feature.

Vehicle brake systems typically include a treadle device having a foot pedal that an operator uses to apply the vehicle brakes. By operating the pedal, the driver causes pressure to be applied to one or more brake actuators to apply the vehicle brakes to slow down a vehicle while driving, for example. Depending on the vehicle, there are wide variations among brake system components. Heavy vehicles, such as trucks, typically include a pressure source because the brake system is pneumatically actuated. Passenger cars, on the other hand, typically include a fluid reservoir where fluid pressure is increased by pedal activation by the driver.

A variety of situations occur where brake application is desired even though the driver is not currently driving the vehicle. One such example is when a heavy vehicle driver needs to periodically inspect the brake operation. Because drivers are often alone, they do not have another individual present to apply brake pressure using the treadle device while the driver is in a position (typically outside of the cab at the rear of the vehicle) to inspect the brake actuator operation.

Another scenario where remote brake application is desired is when a trailer is attached to a passenger vehicle. Electrical connections typically must be made between the main vehicle brake system and brake lights on the trailer. When an individual is alone, it is not possible for the individual to be within the vehicle applying the brakes and standing behind the trailer to inspect whether the brake lights are properly attached or operating.

Variations and combinations of the two preceding scenarios also exist and present situations where remote brake application is desirable.

Accordingly, there is a need for a vehicle brake system where remote application of the brakes is possible without requiring an individual to operate the pedal device normally used to apply the brakes while driving the vehicle, for example. This invention addresses that need.

### SUMMARY OF THE INVENTION

In general terms, this invention is a vehicle brake system that includes a remote brake application feature. A system designed according to this invention includes a pedal device that is normally operated to apply the brakes. A signaling device generates a signal indicating a desire to apply the brakes. A controller responds to the signaling device signal and causes the brakes to be applied independent of manual activation of the pedal device.

In one example, the signaling device is a remote signaling device that generates a wireless communication signal that is then received by a receiver portion of the controller. In one example, the signaling device is part of a key fob, which may also provide other functions for a vehicle owner such as controlling door locks.

This invention provides the ability to apply the vehicle brakes without requiring operation of the manually actuated brake pedal. Additionally, this invention allows an individual to inspect the operation of the brake lights while standing in a position where the brake lights can be easily observed.

The various features and advantages of this invention will become apparent to those skilled in the art from the following detailed description of the currently preferred embodiment. The drawing that accompany the detailed description can be briefly described as follows.

### BRIEF DESCRIPTION OF THE DRAWING

The figure schematically illustrates a brake system designed according to this invention incorporated on a sample vehicle.

### DETAILED DESCRIPTION OF THE PREFERRED EMBODIMENT

A vehicle brake system 20 is used to selectively slow down a vehicle 22 under normal driving conditions. The illustrated vehicle 22 is a truck having a trailer portion. This invention is not limited, however, to trucks. This invention is equally applicable to passenger vehicles, heavy vehicles and other vehicles, especially where a trailer portion may be selectively attached to the vehicle.

A brake treadle device 23 includes a conventional brake pedal 24 that is manually manipulated by a driver of the vehicle 22 to apply the brakes. A conventional pressure source 26 provides pressure to apply the brakes. The pressure source 26 is schematically shown and may be, in some cases a conventional pneumatic pressure source or a reservoir of brake fluid, depending on the particulars of a specific vehicle brake system. Operating the pedal 24 operates a valve 28 that selectively couples the pressure source 26 with brake supply lines 30 to apply pressure to brake actuators 32 and 34 to apply the brakes. The pressure source 26 and brake actuators 32 and 34 operate in a conventional manner.

When the brakes are applied, brake lights 36 and 38 preferably light up, assuming that they are operating as intended and the light sources (i.e., light bulbs) are fully functional.

The system 20 includes a controller 40 that is supported on the vehicle 22. The controller 40 communicates with an auxiliary valve 42. The controller 40 operates the valve 42 to selectively couple the pressure source 26 to the supply conduits 30 to apply the brakes without requiring manual activation of the pedal 24. The controller 40 effectively provides an automated brake application.

The controller 40 may be a dedicated, conventional microprocessor or a portion of another controller already on the vehicle. Those skilled in the art who have the benefit of this description will be able to select from among commercially available components and to suitably program a controller to achieve the results provided by this invention.

The system 20 includes a signaling device 44 to provide a signal to the controller 40 indicating that such an automated brake application is desired. The illustrated example includes a remote signaling device 44 that comprises a key fob. A plurality of switches 46 and 48 on the key fob allow the vehicle owner to generate one or more desired signals. In one example, the switch 46 is used to generate a door lock or unlock signal while the switch 48 is used to generate a signal schematically illustrated at 50 indicating a desire to have the brakes applied by the controller 40 independent of the pedal 24.

A remote signaling device allows a vehicle operator to stand at any location within a selected vicinity of the vehicle 22 and have the brakes automatically applied so that operation of various brake components may be observed. For example, a heavy vehicle operator may be able to stand in a position to observe the brake actuators while having the brakes applied without requiring any individual present in the cab of the vehicle. In another example, a vehicle owner who attaches a trailer to the rear of the vehicle can have the brakes applied to inspect whether an electrical connection to the brake lights on the trailer was properly made. Further, application of the brakes from a remote location allows the vehicle owner to stand behind the vehicle and observe the operation of the brake lights 36 and 38 to be sure that no replacement or repair is necessary.

In vehicle brake systems where the brake lights are normally activated by applying pressure to the pedal 24, the controller 40 preferably controls operation of the brake lights 36 and 38 responsive to a signal from the signaling device 44 so that the brake lights will be turned on during the requested automated brake application. In other brake systems, a pressure signal within the supply lines 30 automatically causes brake light illumination. In the latter type of system the components responsible for brake light activation preferably are placed within the supply lines 30 so that automatic brake application causes the brake lights to turn on so that the controller 40 need not separately control the brake lights.

There are a variety of strategies for controlling the automated brake application provided by this invention. For example, activation of the switch 48 provides a signal to the controller indicating a desire to have the brakes temporarily applied and then released. In this example, the controller 40 preferably is programmed to apply the brakes for some pre-selected period of time and then to release the brakes.

In another example, the controller 40 is responsive to an on signal from the signaling device 44 such that the controller 40 automatically applies the brakes. In this example, the brakes remain applied until an off signal is received from the signaling device 44. In this particular example, individual brake on and brake off switches preferably are provided for an individual to selectively apply and then release the brakes as desired.

Not only does this invention include a variety of automated of brake application strategies, but also may include control functions that avoid inadvertent application of the brakes using the signaling device 44.

In one example, the controller 40 is programmed to determine whether the vehicle 22 is being driven. The controller 40 may make such a determination by gathering information from one or more conventional vehicle sensors that indicate the state of a vehicle transmission, engine RPM, wheel acceleration, etc. The controller 40 preferably will not respond to a brake application signal from the signaling device 44 when the vehicle is in motion. This avoids the possibility for an individual to inadvertently press a brake application switch on the signaling device 44 while the vehicle is in motion when the driver does not intend to apply the brakes.

Another example implementation of this invention includes requiring multiple switches to be activated before the brake application signal is transmitted from the signaling device 44 to the controller 40. For example, the brake application signal may not be generated and transmitted until the user activates switch 46 followed by switch 48 within a selected amount of time. Another example requires simultaneous switch activation. A variety of switch activation scenarios to avoid inadvertent brake application are within the scope of this invention.

An optional, additional control strategy includes programming the controller to recognize an encrypted or coded signal. Rolling codes or other encryption techniques, as known, may be used. In one example the signal from the signaling device 44 includes a rolling code. The controller is programmed to recognize only an acceptable signal in accordance with the rolling code of the dedicated signaling device 44. That way, a signal from another vehicle's signaling device is not utilized by the controller as a signal indicating a desire to automatically apply the brakes.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A vehicle brake system, comprising:
a treadle device that an operator manually uses to apply the vehicle brakes;
a signaling device that provides a signal indicating a desire to apply the brakes; and
a controller that causes the brakes to be applied responsive to the signal from the remote signaling device without requiring manual operation of the treadle device.

2. The system of claim 1, wherein the signaling device generates a wireless communication signal that is received by the controller.

3. The system of claim 2, wherein the signaling device comprises a key fob.

4. The system of claim 1, including a pressure source and an auxiliary valve coupled between the pressure source and the vehicle brakes to selectively apply the brakes without requiring manual activation of the treadle device and wherein the controller operates the auxiliary valve responsive to the signaling device signal.

5. The system of claim 4, including at least one brake actuator that is actuated by pressure normally applied by operating the treadle device and wherein the auxiliary valve is operative to provide pressure to actuate the actuator.

6. The system of claim 1, including brake lights that indicate when the vehicle brakes are applied and wherein the controller turns on the brake lights responsive to the signaling device signal.

7. The system of claim 1, wherein the controller is operative to determine whether the vehicle is being driven and the controller only applies the brakes responsive to the signaling device signal when the vehicle is not being driven.

8. A method of controlling a vehicle brake system that has brakes that normally are applied using a manually activated treadle device and a controller that operates the brakes without requiring manual activation of the treadle device, comprising the steps of:
generating a signal indicating a desire to apply the brakes independent of the treadle device; and
applying the brakes responsive to the generated signal, using the controller.

9. The method of claim 8, including turning on brake lights responsive to the generated signal.

10. The method of claim 8, including generating the signal using a remote signaling device that generates a wireless communication signal.

11. The method of claim 8, wherein the brake system includes a pressure source that provides pressure to apply the brakes and an auxiliary valve that couples the brakes to the pressure source independent of the treadle device and wherein the controller operates the auxiliary valve to apply the brakes responsive to the generated signal.

12. The method of claim 8, including determining whether the vehicle is being driven and applying the brakes responsive to the generated signal only when the vehicle is not being driven.

13. The method of claim 12, including determining a speed of the vehicle.

14. The method of claim 8, including continuing to apply the brakes responsive to the generated signal until another signal is received indicating a desire to release the brake application.

15. The method of claim 8, including applying the brakes responsive to the generated signal for a pre-selected period of time and then automatically releasing the brakes.

16. The method of claim 8, including generating the signal by requiring a plurality of switch activations.
